(19) United States
(12) Patent Application Publication
(10) Pub. No.: US 2015/0169063 A1
(43) Pub. Date: Jun. 18, 2015

(54) OPERATION DEVICE

(71) Applicant: KABUSHIKI KAISHA TOKAI RIKA DENKI SEISAKUSHO, Aichi (JP)

(72) Inventor: Daisaku GOTO, Aichi (JP)

(21) Appl. No.: 14/564,741

(22) Filed: Dec. 9, 2014

(30) Foreign Application Priority Data
Dec. 13, 2013 (JP) 2013-257880

(51) Int. Cl. G06F 3/01; G06F 3/041

(52) U.S. Cl. CPC G06F 3/016; G06F 3/041

(57) ABSTRACT

An operation device includes a detecting portion that detects an operation performed on an operation surface by a detection target, a plurality of vibration generating portions that are arranged on a back surface opposite to the operation surface to vibrate the detecting portion in a normal direction of the operation surface and a direction opposite thereto, a coordinate calculation section that calculates coordinates of a guide position on the operation surface based on acquired guide information, the guide position being a destination of the detection target being guided, and a control unit that determines a pressure gradient of an air layer formed on the operation surface by vibration of the detecting portion based on the coordinates of the guide position calculated by the coordinate calculation section and controls the plurality of vibration generating portions so that the determined pressure gradient is formed.

The present application is based on Japanese patent application No. 2013-257880 filed on Dec. 13, 2013, the entire contents of which are incorporated herein by reference.

### BACKGROUND OF THE INVENTION

1. Field of the Invention

The invention relates to an operation device for operating on-vehicle electronic devices etc.

2. Related Art

A touch interface is known which is provided with a vibrating operation surface and a vibration generating means configured to vibrate the vibrating operation surface to produce mechanical deformation thereon so as to change the sense of touch at the time of touching the operation surface (see e.g. JP-A-2010-518500).

The touch interface operates such that the operation surface is vibrated by ultrasonic waves so as to allow the operator to perceive a detectable texture or roughness on the operation surface.

### SUMMARY OF THE INVENTION

The conventional touch interface may cause a problem that the operator needs to operate it while fixing eyes on the operation surface (i.e., items displayed thereon), e.g., when operating a cursor displayed on the operation surface disposed at a distant position.

It is an object of the invention to provide an operation device that can reduce the eye movement of the operator and can improve the operability.

(1) According to one embodiment of the invention, an operation device comprises:

a detecting portion that detects an operation performed on an operation surface by a detection target;

a plurality of vibration generating portions that are arranged on a back surface opposite to the operation surface to vibrate the detecting portion in a normal direction of the operation surface and a direction opposite thereto;

a coordinate calculation section that calculates coordinates of a guide position on the operation surface based on acquired guide information, the guide position being a destination of the detection target being guided; and

a control unit that determines a pressure gradient of an air layer formed on the operation surface by vibration of the detecting portion based on the coordinates of the guide position calculated by the coordinate calculation section and controls the plurality of vibration generating portions so that the determined pressure gradient is formed.

### Advantageous Effects of the Invention

According to one embodiment of the invention, an operation device can be provided that can reduce the eye movement of the operator and can improve the operability.

### BRIEF DESCRIPTION OF THE DRAWINGS

Next, the present invention will be explained in more detail in conjunction with appended drawings, wherein:

FIG. 1A is a schematic view showing the inside of a vehicle mounting an operation device in a first embodiment;

FIG. 1B is a top view showing the operation device;

FIG. 2A is a block diagram illustrating the operation device in the first embodiment;

FIG. 2B is a schematic view showing a connection relation in which the operation device is electromagnetically connected to an in-vehicle LAN;

FIG. 3A is a schematic view showing a state in which the operation device in the first embodiment is not vibrating;

FIG. 3B is an explanatory schematic view showing a pressure gradient formed by the operation device;

FIG. 4 is a flowchart for explaining an operation of the operation device in the first embodiment;

FIG. 5A is a schematic view showing a display image for explaining an operation of an operation device in a second embodiment when there are plural guide positions;

FIG. 5B is a schematic view showing an operation surface in such a case; and

FIG. 6 is a flowchart for explaining an operation of the operation device in the second embodiment.

### DETAILED DESCRIPTION OF THE PREFERRED EMBODIMENTS

### Summary of the Embodiments

Operation devices of the embodiments are generally composed of a detecting portion which detects an operation performed on an operation surface by a detection target; plural vibration generating portions which are arranged on a back surface opposite to the operation surface to vibrate the detecting portion in a normal direction of the operation surface and a direction opposite thereto; a coordinate calculation section which calculates coordinates of a guide position on the operation surface based on acquired guide information, the guide position being a destination of the detection target being guided; and a control unit which determines a pressure gradient of an air layer formed on the operation surface by vibration of the detecting portion based on the coordinates of the guide position calculated by the coordinate calculation section and controls the plural vibration generating portions so that the determined pressure gradient is formed.

The operation devices can guide a detection target to a guide position on the operation surface using a pressure gradient of the air layer formed on the operation surface and it is thus possible to reduce eye movement and to improve operability as compared to the case where pressure on the operation surface is substantially uniform.

### First Embodiment

### Overall Configuration of Operation Device 1

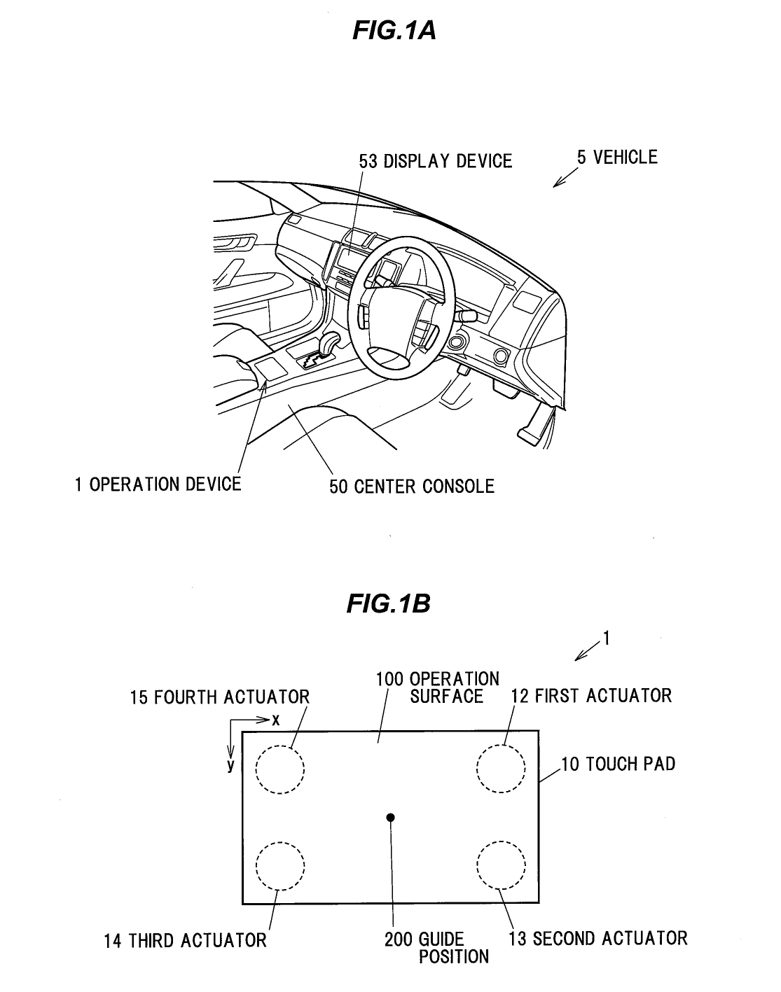

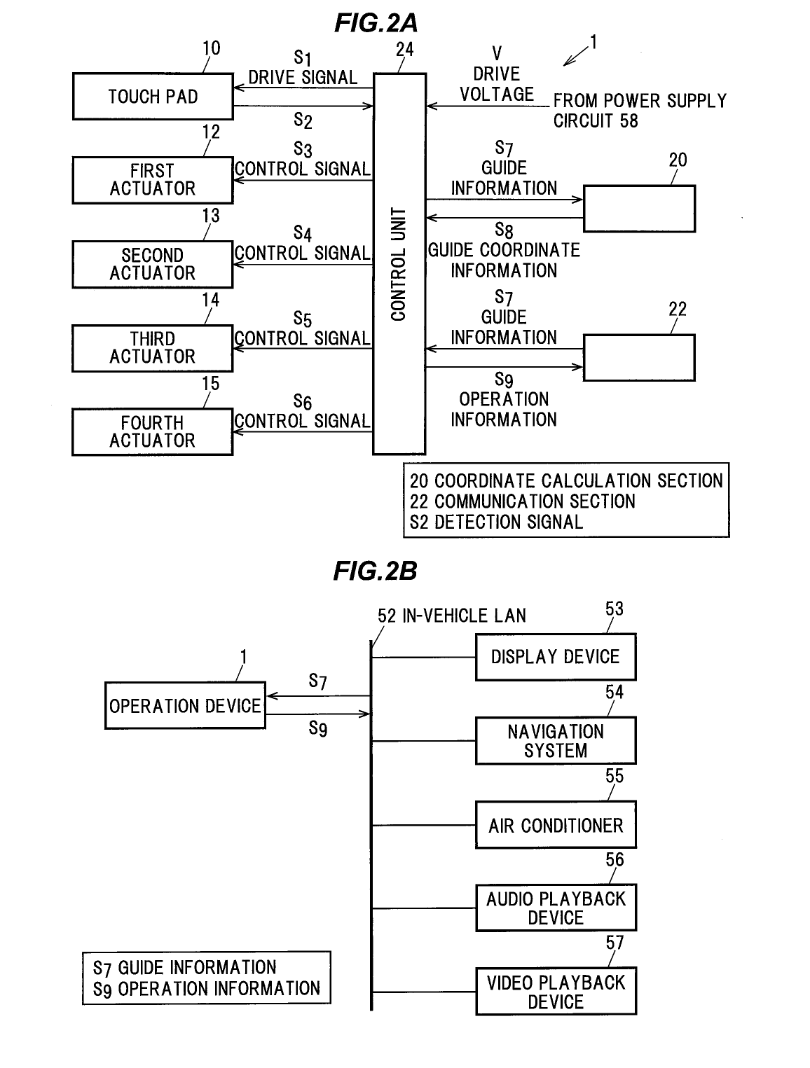

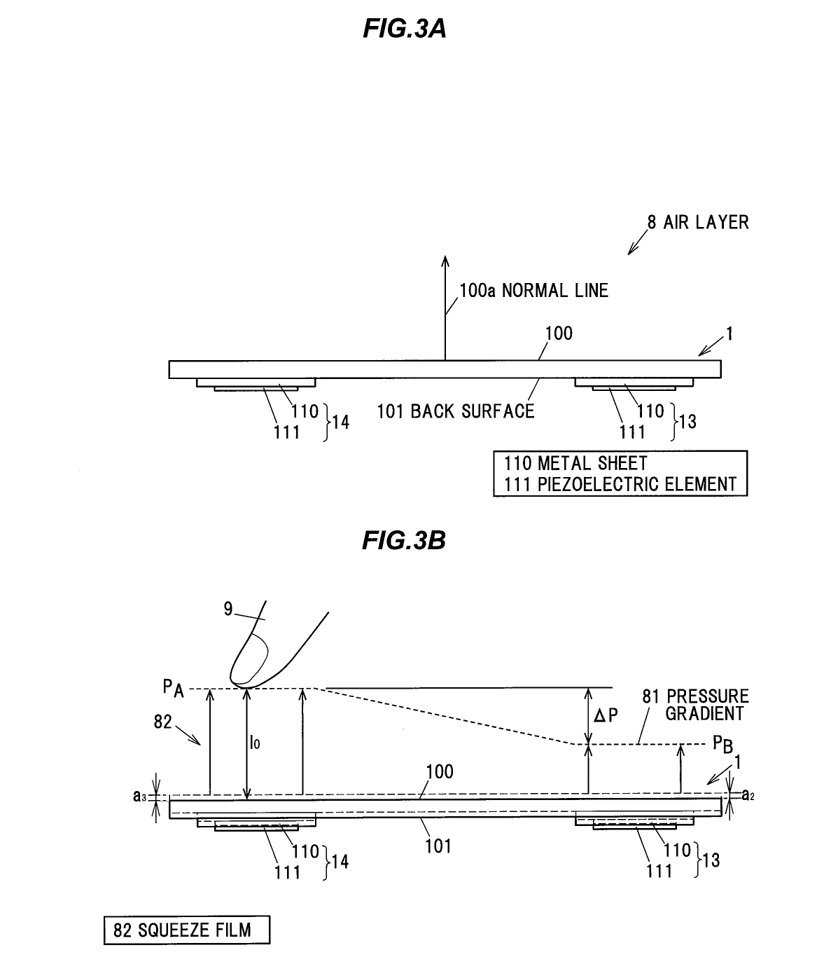

FIG. 1A is a schematic view showing the inside of a vehicle mounting an operation device in the first embodiment and FIG. 1B is a top view showing the operation device. FIG. 2A is a block diagram illustrating the operation device in the first embodiment and FIG. 2B is a schematic view showing a connection relation in which the operation device is electromagnetically connected to an in-vehicle LAN (Local Area Network). FIG. 3A is a schematic view showing a state in which the operation device in the first embodiment is not vibrating and FIG. 3B is an explanatory schematic view showing a pressure gradient formed by the operation device. It should be noted that, in each drawing of the embodiments described below, a proportion of illustrated components may be different from an actual proportion. In addition, in FIGS. 2A and 2B, flows of main signals and information are indicated by arrows.

The operation device 1 is arranged on, e.g., a center console 50 located between a driver's seat and a front passenger seat of a vehicle 5, as shown in FIG. 1A. The operation device 1 is electromagnetically connected to electronic devices mounted on the vehicle 5. Note that, the position to arrange the operation device 1 is not limited to the center console 50 and can be arranged at an arbitrary place.

The operation device 1 is configured to allow an operation by, e.g., a portion of the body of an operator (e.g., a finger) or a special pen to move or select a cursor displayed on a display device 53 functioning as a display portion of the electronic devices or to give instructions such as selecting, assigning, dragging or dropping the displayed icon. This operation is performed on an operation surface 100 shown in FIG. 1B. The operation surface 100 is exposed on the center console 50. In the present embodiments, an operation performed by a finger as a detection target will be described. Note that, the icons are, e.g., data of various types or processing functions which are displayed as a picture or character/letter on the display screen of the display device 53 and selection thereof causes an allocated command to be executed.

The display device 53 is arrange on, e.g., an instrument panel 51 located on the front left hand of an operator who sits on the driver's seat.

Here, electromagnetic connection mentioned above is connection using at least one of a conductive material, light as a kind of electromagnetic wave and radio wave as a kind of electromagnetic wave. In addition, the electronic devices mentioned above include e.g., a navigation system 54, an air conditioner 55, a music playback device 56 and a video playback device 57 and are electromagnetically connected to the operation device 1 via an in-vehicle LAN 52.

As shown in FIGS. 2A, 3A and 3B, the operation device 1 is generally composed of a touch pad 10 as a detecting portion which detects an operation performed on the operation surface 100 by a finger, plural vibration generating portions which are arranged on a back surface 101 opposite to the operation surface 100 to vibrate the touch pad 10 in a direction of a normal line 100a of the operation surface 100 and a direction opposite thereto, a coordinate calculation section 20 which calculates coordinates of a guide position 200 as a destination of the guided finger on the operation surface 100 based on acquired guide information S₇, and a control unit 24 which determines a pressure gradient 81 of an air layer 8 formed on the operation surface 100 by vibration of the touch pad 10 based on the coordinates of the guide position 200 calculated by the coordinate calculation section 20 and controls the plural vibration generating portions so that the determined pressure gradient 81 is formed.

The plural vibration generating portions are first to fourth actuators 12 to 15 as an example. Note that, the number of the vibration generating portions is not limited to four and can be changed according to the technical specification of the operation device 1.

Configuration of Touch Pad 10

The touch pad 10 is, e.g., a touch sensor which detects a position on the operation surface 100 touched by a finger. As the touch pad 10, it is possible to use e.g., a well-known resistive, infrared or capacitive touch pad, etc.

The touch pad 10 is, e.g., a capacitive touch pad detecting variation in current which is caused by contact of the finger with the operation surface 100 and is inversely proportional to a distance between sensor wires and the finger. The sensor wires are intersected and provided under the operation surface 100.

The touch pad 10 has a laminated structure composed of, e.g., a protective layer formed of a resin or glass, etc., and a sensor layer formed by arranging the sensor wires, etc.

The operation surface 100 of the touch pad 10 is configured that, on the paper plane of FIG. 1B, an origin is the top left, the x-axis is from left to right and the y-axis is from top to bottom. In addition, there is a one-to-one correspondence between the operation surface 100 of the touch pad 10 and the display screen of the display device 53 and a coordinate system of the touch pad 10 is an absolute coordinate system.

The operation device 1 is driven by, e.g., drive voltage V supplied through a power supply circuit 58 of the vehicle 5. A drive signal S₁ generated based on the drive voltage V is supplied to the touch pad 10. The touch pad 10 is configured to periodically perform detection of a finger according to the drive signal S₁ and then to output a detection signal S₂.

Configuration of First to Fourth Actuators 12 to 15

The first to fourth actuators 12 to 15 are, e.g., monomorph piezoelectric actuators provided with a metal sheet 110 and a piezoelectric element 111, as shown in FIG. 3A. The monomorph piezoelectric actuator is an actuator having a structure to bend using only one piezoelectric element 111. As a modification of the first to fourth actuators 12 to 15, bimorph piezoelectric actuators in which two piezoelectric elements are provided on both surfaces of a metal sheet may alternatively be used. It should be noted that, since the first to fourth actuators 12 to 15 have the same structure, the metal sheets and the piezoelectric elements thereof are denoted by respectively the same reference numerals.

The metal sheet 110 has a circular shape. In addition, the metal sheet 110 is formed of, e.g., a metal material having conductivity such as aluminum, nickel, copper or iron, an alloy material containing thereof, or an alloy material such as stainless steel. Alternatively, the metal sheet 110 may be formed of a non-conductive material, e.g., synthetic resin etc.

The piezoelectric element 111 contracts by, e.g., voltage supplied thereto. The contraction causes the metal sheet 110 to bend and the bending generates vibration.

A material used for the piezoelectric element 111 is, e.g., lithium niobate, barium titanate, lead titanate, lead zirconate titanate (PZT), lead metaniobate or polyvinylidene fluoride (PVDF), etc. The piezoelectric element 111 is, e.g., a laminated piezoelectric element formed by laminating films of such materials.

The first to fourth actuators 12 to 15 are arranged at, e.g., four corners of the operation surface 100 clockwise from the top right in FIG. 1B.

The first actuator 12 applies vibration to the touch pad 10 based on a control signal S₃ output from the control unit 24. The second actuator 13 applies vibration to the touch pad 10 based on a control signal S₄ output from the control unit 24. The third actuator 14 applies vibration to the touch pad 10 based on a control signal S₅ output from the control unit 24. The fourth actuator 15 applies vibration to the touch pad 10 based on a control signal S₆ output from the control unit 24.

It is desirable that the first to fourth actuators 12 to 15 vibrate at a high frequency inaudible to human ears. It is because vibration in a range audible to operator's ears is noise to the operator. Therefore, the resonant frequency of the actuator is preferably not less than 10 kHz and not more than 100 kHz, more preferably, not less than 20 kHz and not more than 100 kHz.

Each of the first to fourth actuators 12 to 15 activates the touch pad 10 in the direction of the normal line 100a and a direction opposite thereto, i.e., applies vibration to the touch pad 10 to allow the pressure gradient 81 to be formed on the operation surface 100 by the squeeze effect.

The squeeze effect is an effect in which, for example, a force applied from the operation surface 100 to the air layer 8 in the direction of the normal line 100a due to vibration of the operation surface 100 causes an increase in pressure on the operation surface 100 in the direction of the normal line 100a and a squeeze film 82, like an air film, is thereby formed between a finger 9 and the operation surface 100, as shown in FIG. 3B. Due to the squeeze film 82, the finger 9 and the operation surface 100 are practically not in contact with each other, apparent friction is reduced and smooth finger slide is provided.

The control unit 24 of the operation device 1 is configured to generate the control signals S₃ to S₆ corresponding to the guide position 200 based on the following formula (1):

P=Po·lo/(lo−a·Sin(2πft)) (1)

P: Mean pressure under the squeeze effect
Po: Mean ambient pressure
lo: Distance between the finger and the touch pad 10
a: Displacement amount of the touch pad 10
f: Resonant frequency

The mean pressure P corresponds to pressure P_{A} and pressure P_{B} shown in FIG. 3B. Po is a mean ambient pressure and is, e.g., pressure in a region not affected by the squeeze effect. The distance lo between the finger and the touch pad 10 is, e.g., an expected distance. The displacement amount a of the touch pad 10 is controlled to be, e.g., not less than 5 μm and not more than 20 μm. The resonant frequency f is set to between, e.g., not less than 20 kHz and not more than 100 kHz.

When forming, e.g., the pressure gradient 81 shown in FIG. 3B, for example, a displacement amount a₃ of the third actuator 14 and a displacement amount a₄ of the fourth actuator 15 are set to be relatively larger than a displacement amount a₁ of the first actuator 12 and a displacement amount a₂ of the second actuator 13. In this case, the displacement amounts a₁ and a₂ are substantially the same value and the displacement amounts a₃ and a₄ are substantially the same value. The first to fourth actuators 12 to 15 here are driven in the same phase at the same resonant frequency.

This vibration generates the mean pressure P_{A} above the third actuator 14 and the fourth actuator 15 and generates the mean pressure P_{B} above the first actuator 12 and the second actuator 13, as shown in FIG. 3E.

Since the mean pressure P_{A} is larger than the mean pressure P_{B} by ΔP, the pressure gradient 81 is generated on the operation surface 100. Therefore, friction increases from left to right in FIG. 3B. As a result, the operator feels that the finger 9 is guided in an operating direction when moving the finger 9 from right to left in FIG. 3B and, on the other hand, feels that friction gradually increases, i.e., resistance is acting against the operation being performed when moving the finger 9 from left to right.

As such, the control unit 24 adjusts the displacement amount and phase of the first to fourth actuators 12 to 15 based on the guide position 200. This allows the pressure gradient 81 to be controlled not only on the x-y plane but also in a θ direction from the x-y plane and it is thus possible to guide a finger to a given position on the operation surface 100.

Configuration of Coordinate Calculation Section 20

The coordinate calculation section 20 is configured to calculate, based on the acquired guide information S₇, coordinates of the guide position 200 to which the finger is guided.

The guide information S₇ is, e.g., output from an electronic device connected to the operation device 1. The coordinate calculation section 20 acquires the guide information S₇ via a communication section 22 and the control unit 24.

In addition, the coordinate calculation section 20 is configured to calculate coordinates of the guide position 200 based on the guide information S₇, to produce guide coordinate information S₈ including information of the coordinates and to outputs the guide coordinate information S₈ to the control unit 24.

The guide information S₇ includes, e.g., information of guide source position on a display image displayed on the display device 53. When the display device 53 displays a selectable icon at, e.g., the center of the display screen, the guide position 200 based on the guide source position is on the coordinates of the center of the operation surface 100, as shown in FIG. 1B. By the coordinate calculation section 20, the coordinates of the center of the operation surface 100 are derived as the guide position 200 and the guide coordinate information S₈ including information of such coordinates is produced and output to the control unit 24.

In addition, the guide information S₇ is output from the electronic device based on, e.g., switching of the display images. As such, the operation device 1 is configured to switch between vibration for guiding the finger and vibration for providing smooth finger slide based on the guide information S₇ indicating the switching when the display image on the display device 53 is switched.

Configuration of Communication Section 22

The communication section 22, which is electromagnetically connected to the in-vehicle LAN 52, is configured to acquire the guide information S₇ and to output operation information S₉ therethrough.

Configuration of Control Unit 24

The control unit 24 is, e.g., a microcomputer composed of a CPU (Central Processing Unit) performing calculation and processing, etc., of the acquired data according to a stored program, a RAM (Random Access Memory) and a ROM (Read Only Memory) which are semiconductor memories. The ROM stores, e.g., a program for operation of the control unit 24. The RAM is used as, e.g., a storage area for temporarily storing calculation results, etc. In addition, the control unit 24 has, inside thereof, a means for generating clock signals and is operated based on the clock signals.

The control unit 24 is configured to calculate the required pressure gradient 81 based on the guide position 200 in the guide coordinate information S₈ and to determine the control signals S₃ to S₆ supplied to the first to fourth actuators 12 to 15 based on the calculated pressure gradient 81 and the formula (1).

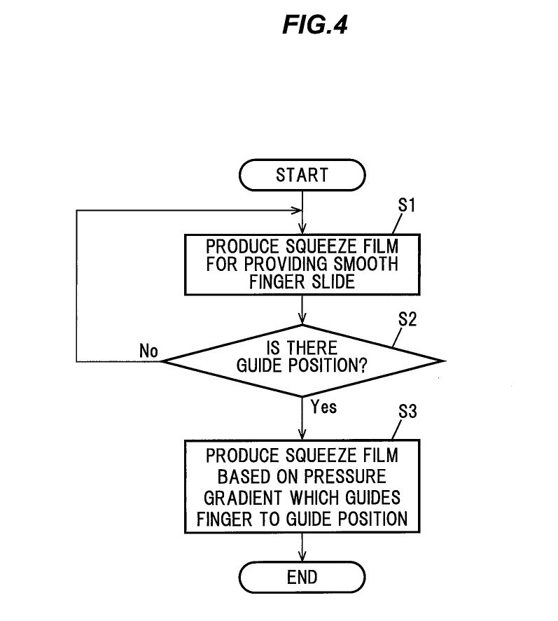

An operation of the operation device 1 in the first embodiment will be described below in accordance with the flowchart of FIG. 4.

Operation

Firstly, when the vehicle 5 is powered on, the drive voltage V is supplied to the operation device 1 from the power supply circuit 58 of the vehicle 5.

By the control unit 24 of the operation device 1, the drive signal S₁ is generated based on the clock signal and is then output to the touch pad 10, and also, the control signals S₃ to S₆ for forming the squeeze film 82 on the operation surface 100 are generated and then output to the first to fourth actuators 12 to 15 (S1).

The first to fourth actuators 12 to 15 apply vibration to the operation surface 100 based on the acquired control signals S₃ to S₆ to form the squeeze film 82 for providing smooth finger slide.

Once the guide information S₇ is acquired from the electronic device via the communication section 22, the control unit 24 judges that there is a guide position 200 (S2: Yes) and outputs the guide information S₇ to the coordinate calculation section 20.

The coordinate calculation section 20, which acquired the guide information S₇ via the communication section 22 and the control unit 24, calculates the guide position 200, produces the guide coordinate information S₈ and outputs the guide coordinate information S₈ to the control unit 24.

The control unit 24, which acquired the guide coordinate information S₈, calculates the pressure gradient 81 for guiding the finger to the guide position 200, generates the control signals S₃ to S₆ based on the calculated pressure gradient 81 and outputs the control signals S₃ to S₆ to the first to fourth actuators 12 to 15 so that the squeeze film 82 with the calculated pressure gradient 81 is formed (S3).

Here, when it is judged in Step 2 that there is no designated guide position 200 (S2: No), the control unit 24 returns the process to Step 1 to form the squeeze film 82 for providing smooth finger slide.

The operation device 1 continuously performs this series of processes while the drive voltage V is supplied.

### Effects of the First Embodiment

Since the operation device 1 in the first embodiment can guide the finger 9 to the guide position 200 on the operation surface 100 using the pressure gradient 81 of the air layer 8 on the operation surface 100, it is possible to reduce eye movement and to improve operability as compared to the case where pressure on the operation surface 100 is uniform.

In the operation device 1, the squeeze film 82 for providing smooth finger slide is formed when the finger is not guided. Therefore, operability is more improved than the case where a squeeze film is not formed.

### Second Embodiment

The second embodiment is different from the first embodiment in that there are plural guide positions.

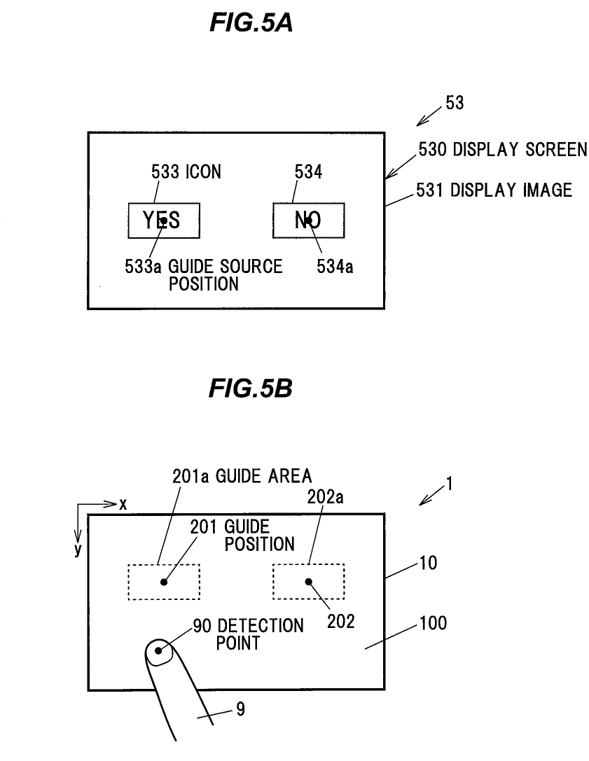

FIG. 5A is a schematic view showing a display image for explaining an operation of an operation device in the second embodiment when there are plural guide positions and FIG. 5B is a schematic view showing an operation surface in such a case. Note that, in the second embodiment, portions having the same functions and configurations as the first embodiment are denoted by the same reference numerals as the first embodiment and the explanation thereof will be omitted.

The coordinate calculation section 20 in the second embodiment is configured to acquire the guide information S₇ including information of plural guide source positions and to calculate coordinates of plural guide positions on the operation surface 100 which correspond to the acquired plural guide source positions. The guide source positions in the second embodiment are, e.g., guide source positions 533a and 534a which are the respective centers of an icon 533 showing a word “YES” and the icon 534 showing a word “NO” included in a display image 531, as shown in FIG. 5A.

Meanwhile, the control unit 24 in the second embodiment is configured to control the first to fourth actuators 12 to 15 based on a finger detection point detected by the touch pad 10 as well as the coordinates of the plural guide positions so that the finger is guided to the coordinates of the closest guide position to the detection point on the operation surface 100.

When, for example, the icons 533 and 534 are displayed on a display screen 530 as shown in FIG. 5A, the guide information S₇ is generated by the electronic device so as to include information of the coordinates of the center of the icon 533 and the coordinates of the center of the icon 534 and is output to the operation device 1. As a modification, the guide information S₇ may alternatively include, e.g., information indicating the size of the icons 533 and 534.

The coordinate calculation section 20 calculates a guide position 201 on the touch pad 10 shown in FIG. 5B based on the acquired coordinates of the center of the icon 533. Likewise, the coordinate calculation section 20 calculates a guide position 202 on the touch pad 10 shown in FIG. 5B based on the acquired coordinates of the center of the icon 534. The coordinate calculation section 20 is configured to produce the guide coordinate information S₈ including information of the guide positions 201 and 202 and then to output the guide coordinate information S₈ to the control unit 24.

The following modification may be implemented. When the guide information S₇ includes information of the size of the icons 533 and 534, the control unit 24 sets a guide area 201a corresponding to the icon 533 and a guide area 202a corresponding to the icon 534, as shown in FIG. 5B.

The guide areas 201a and 202a are provided to switch from vibration for guiding the finger to vibration for providing smooth finger slide when a detection point 90 is detected in these areas.

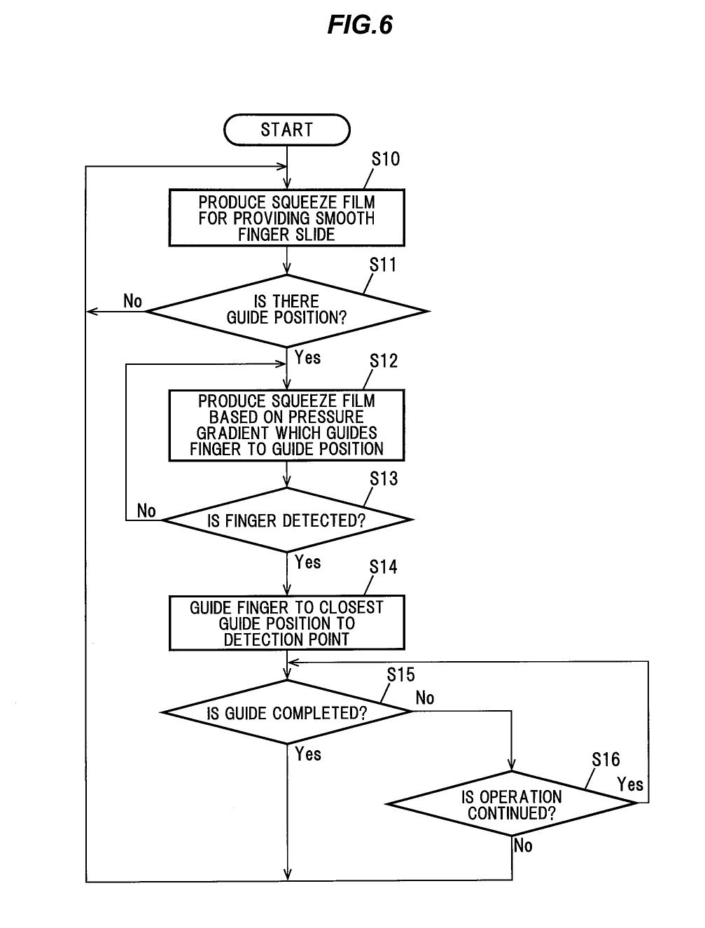

An operation of the operation device 1 in the second embodiment will be described below in accordance with the flowchart of FIG. 6.

Operation

Firstly, when the vehicle 5 is powered on, the drive voltage V is supplied to the operation device 1 from the power supply circuit 58 of the vehicle 5.

By the control unit 24 of the operation device 1, the drive signal S₁ is generated based on the clock signal and is then output to the touch pad 10, and also, the control signals S₃ to S₆ for forming the squeeze film 82 on the operation surface 100 are generated and then output to the first to fourth actuators 12 to 15 (S10).

The first to fourth actuators 12 to 15 apply vibration to the operation surface 100 based on the acquired control signals S₃ to S₆ to form the squeeze film 82 for providing smooth finger slide.

Once the guide information S₇ is acquired from the electronic device via the communication section 22, the control unit 24 judges that there is a guide position 200 (S11: Yes) and outputs the guide information S₇ to the coordinate calculation section 20.

The coordinate calculation section 20, which acquired the guide information S₇ via the communication section 22 and the control unit 24, calculates the guide position 200, produces the guide coordinate information S₈ and outputs the guide coordinate information S₈ to the control unit 24.

The control unit 24, which acquired the guide coordinate information S₈, calculates the pressure gradient 81 for guiding the finger to the guide position 200, generates the control signals S₃ to S₆ based on the calculated pressure gradient 81 and outputs the control signals S₃ to S₆ to the first to fourth actuators 12 to 15 so that the squeeze film 82 with the calculated pressure gradient 81 is formed (S12).

The control unit 24 judges, based on the detection signal S₂, whether or not the finger is detected. When the finger is detected (S13: Yes), the control unit 24 determines the closest guide position to the finger detection point. Here, the closest to the position at which the finger 9 is detected, i.e., to the detection point 90 is assumed to be the guide position 201 corresponding to the icon 533, as shown in FIG. 5B.

Based on the judgment that the guide position 201 is the closest to the detection point 90, the control unit 24 calculates the pressure gradient 81 for guiding the finger to the guide position 201, generates the control signals S₃ to S₆ based on the calculated pressure gradient 81 and outputs the control signals S₃ to S₆ to the first to fourth actuators 12 to 15 so that the squeeze film 82 with the calculated pressure gradient 81 is formed (S14).

When the finger 9 reached the guide position 201 based on the detection signal S₂ (S15: Yes), the control unit 24 returns the process to Step 10 and switches from vibration for guiding the finger to vibration for providing smooth finger slide.

Meanwhile, in case that the guide area 201a is provided in the modification, the control unit 24 switches from vibration for guiding the finger to vibration for providing smooth finger slide based on the detection signal S₂ once the detection point 90 is located inside the guide area 201a.

Here, when it is judged in Step 11 that there is no designated guide position (S11: No), the control unit 24 returns the process to Step 10 to form the squeeze film 82 for providing smooth finger slide.

When it is judged in Step 13 that the finger 9 is not detected (S13: No), the control unit 24 returns the process to Step 12.

When it is judged in Step 15 that the detection point 90 has not reached the guide position 201 (S15: No), the control unit 24 judges whether or not the operation is continued. When the operation is continued (S16: Yes), the control unit 24 returns the process to Step 15. On the other hand, when the operation is not continued (S16: No), for example, when the finger 9 has moved away from the operation surface 100 and is not detected, the control unit 24 returns the process to Step 10.

This series of processes is continuously performed while the drive voltage V is supplied.

### Effects of the Second Embodiment

The operation device 1 in the second embodiment can guide a finger to plural guide positions while reducing eye movement.

In addition, in the modification in which the operation device 1 sets the guide areas, it is possible to switch from vibration for guiding the finger to vibration for providing smooth finger slide by using the guide area to judge whether or not guiding of the finger 9 is completed, unlike the case of not setting the guide area. Therefore, the operator can know that he/she is operating to the desired position while reducing eye movement, hence, improvement in operability. Furthermore, since the operation device 1 is configured that the guide areas are set so as to correspond to the size of the icons, the operator can perform an operation without feeling a difference between the display on the display device 53 and his/her operation.

The operation device 1 in at least one of the embodiments can reduce eye movement and can improve operability.

In the operation device 1 of the embodiments and modifications, a portion thereof is realized by, e.g., a program executed by a computer, ASIC (Application Specific Integrated Circuit) and FPGA (Field Programmable Gate Array), etc., according to the intended use.

Note that, ASIC is an integrated circuit customized for a particular use and FPGA is a programmable LSI (Large Scale Integration).

Although some embodiments and modifications of the invention have been described above, the embodiments and modifications are merely an example and the invention according to claims is not to be limited thereto. These new embodiments and modifications may be implemented in various other forms, and various omissions, substitutions and changes, etc., can be made without departing from the gist of the invention. In addition, all combinations of the features described in the embodiments and modifications are not necessary to solve the problem of the invention. Further, these embodiments and modifications are included within the scope and gist of the invention and also within the invention described in the claims and the equivalency thereof.

What is claimed is:

1. An operation device, comprising:
a detecting portion that detects an operation performed on an operation surface by a detection target;
a plurality of vibration generating portions that are arranged on a back surface opposite to the operation surface to vibrate the detecting portion in a normal direction of the operation surface and a direction opposite thereto;
a coordinate calculation section that calculates coordinates of a guide position on the operation surface based on acquired guide information, the guide position being a destination of the detection target being guided; and
a control unit that determines a pressure gradient of an air layer formed on the operation surface by vibration of the detecting portion based on the coordinates of the guide position calculated by the coordinate calculation section and controls the plurality of vibration generating portions so that the determined pressure gradient is formed.

2. The operation device according to claim 1, wherein the coordinate calculation section when acquiring the guide information including information of a plurality of guide source positions calculates coordinates of a plurality of guide positions on the operation surface that correspond to the plurality of guide source positions, and the control unit controls the plurality of vibration generating portions to guide the detection target to the closest guide position to a detection point of the detection target detected by the detecting portion based on the detection point and the coordinates of the plurality of guide positions.

3. The operation device according to claim 1, wherein the coordinate calculation section acquires the guide information including information of guide source positions on a display image displayed on a display device.

4. The operation device according to claim 1, wherein the plurality of vibration generating portions comprise at least two vibration generating portions to vibrate with a displacement amount different from each other so as to form the pressure gradient of the air layer on the operation surface.

5. The operation device according to claim 4, wherein the plurality of vibration generating portions comprise at least one vibration generating portion to vibrate with a displacement amount of zero.

6. The operation device according to claim 1, wherein the plurality of vibration generating portions are each disposed at a corner of the back surface.

7. The operation device according to claim 1, wherein the operation device further comprises a touch pad, and
wherein the plurality of vibration generating portions comprise a monomorph piezoelectric actuator or a bimorph piezoelectric actuator.

8. The operation device according to claim 1, wherein the pressure gradient of the air layer is formed by at least two of the vibration generating portions to vibrate with a displacement amount different from each other and to form a pressure applied from the operation surface to the air layer periodically according to a frequency of the vibration of the vibration generating portions.
